(19) United States
(12) Patent Application Publication
(10) Pub. No.: US 2006/0076199 A1
(43) Pub. Date: Apr. 13, 2006

(54) Brake band

(75) Inventors: Hiroyuki Kinpara, Fukuroi-shi (JP); Yoshihisa Harada, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 11/245,032

(22) Filed: Oct. 7, 2005

(30) Foreign Application Priority Data
Oct. 8, 2004 (JP) 2004-295794

(51) Int. Cl. F16D 51/00

(52) U.S. Cl. 188/77 R

(57) ABSTRACT

The present invention provides a brake band in which brackets are joined to ends of a curved strap and a friction material is provided on an inner surface of the strap and wherein stress reducing means for reducing axial stress are provided on the strap.

### BACKGROUND OF THE INVENTION

1. Field of the Invention

The present invention relates to a brake band used in an automatic transmission, for example for a motor vehicle, and more particularly, it relates to a brake band in which stress reducing means are provided in a strap.

2. Related Background Art

In general, a brake band comprises an annular strap which is cut at one portion, brackets provided at the cut ends of the strap and a friction member secured to an inner peripheral surface of the strap and is constructed by wrapping the strap around a drum by applying a force to the apply side bracket by means of an apply pin so that a brake force can be obtained.

In general, the brackets are secured to the ends of the strap by means of caulking. For example, as disclosed in Japanese Utility Model Application Laid-open No. 63-133648 (1988), a rivet recessed portion 5 of an apply side bracket 2 is inserted into an aperture of a strap 1 made of steel sheet and the apply side bracket 2 is joined to the strap 1 by caulking that portion.

However, the above-mentioned conventional brake band has the following problem. That is to say, since stress acts on the strap by the caulking operation performed when the brackets are joined to the strap, the strap is deformed in an axial direction to create gaps between the strap and the brackets, with the result that undulation is created in the strap in the axial direction. If a friction material is stuck to the undulated strap, the friction material itself will also be undulated. Accordingly, problems regarding dispersion in friction property of the brake band and peeling of the friction material occur.

### SUMMARY OF THE INVENTION

Therefore, an object of the present invention is to provide a brake band in which axial undulation is not created in a strap and a friction material by reducing stress generated when a bracket is joined to the strap by caulking, thereby stabilizing a friction property.

To achieve the above object, the present invention provides a brake band in which brackets are joined to ends of a curved strap and a friction material is adhered to an inner peripheral surface of the strap and wherein stress reducing means is provided to reduce axial stress on the strap.

According to the present invention, the following advantages can be obtained.

Since the stress reducing means is provided to reduce the axial stress on the strap, the stress can be relieved only in the axial direction not to influence upon caulking strength, and dispersion in a friction property can be reduced by reduce axial undulation in the strap. Accordingly, a stable braking performance can be obtained.

### BRIEF DESCRIPTION OF THE DRAWINGS

FIG. 1 is a front view of a brake band according to the present invention;

FIG. 2 is a partial front view of an end of a strap showing a first embodiment of stress reducing means;

FIG. 3 is a partial front view of an end of a strap showing a second embodiment of stress reducing means;

FIG. 4 is a partial front view of an end of a strap showing a third embodiment of stress reducing means;

FIG. 5 is a partial front view of an end of a strap showing a fourth embodiment of stress reducing means;

FIG. 6 is a partial front view of an end of a strap showing a fifth embodiment of stress reducing means;

FIG. 7 is a partial front view of an end of a strap showing a sixth embodiment of stress reducing means; and

FIG. 8 is a partial sectional view taken along the line 8-8 in FIG. 5.

### DESCRIPTION OF THE PREFERRED EMBODIMENTS

Now, the present invention will be fully explained with reference to the accompanying drawings. Incidentally, it should be noted that the following embodiments are merely examples of the present invention and is not intended to limit the present invention. Further, in the drawings, the same or similar parts or elements are designated by the same reference numerals.

FIG. 1 is a front view of a brake band 10 of the present invention. The brake band 10 comprises a substantially annularly formed strap 1 formed from thin steel sheet, an apply side bracket 2 joined to one end 1a of the strap 1, and an anchor side bracket 3 joined to the other end 1b of the strap 1. A friction material 6 is adhered to an inner peripheral surface of the strap 1 by an adhesive or the like. A drum (not shown) is fitted within the strap 1.

The anchor side bracket 3 is provided with an anchor pin 5 for maintaining the end 1b of the strap 1 in a fixed condition. Further, an apply pin 4 driven by a drive mechanism (not shown) abuts against the apply side bracket 2. The apply pin 4 serves to flex the strap 1 by urging the apply side bracket 2 so that the strap 1 is tightened against an outer peripheral surface of the drum (not shown) to shift the ends 1a and 1b of the strap 1 toward each other, thereby generating a braking force.

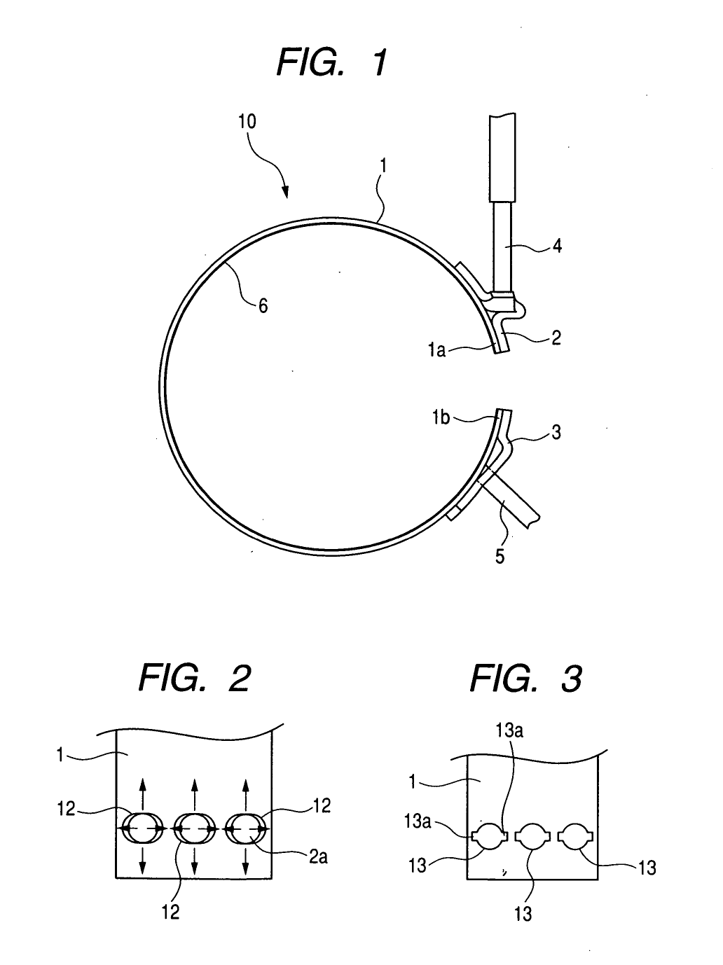

Next, various embodiments of stress reducing means provided on the strap 1 for reducing axial stress will be explained. FIG. 2 is a partial front view of an end of the strap 1, showing a first embodiment of the stress reducing means. Caulking holes 12 provided in the end 1a of the strap 1 are aligned with each other in an axial direction and are disposed substantially equidistantly along the axial direction, and each hole is an elongated hole or a substantially elliptical hole having an axial width greater than a circumferential width.

Projections 2a provided on the apply side bracket 2 are inserted into the caulking holes 12 of the strap 1 and are caulked. As shown by the long arrows and short arrows in FIG. 2, a reaction or repelling force generated when the apply side bracket 2 is joined to the strap 1 by the caulking is greater in the circumferential direction than in the axial direction. Accordingly, although the stress is reduced only in the axial direction, in the circumferential direction, since the required repelling force is generated, the caulking strength is not influenced, with the result that the apply side bracket 2 is firmly secured to the strap 1.

As shown in FIG. 1, although the axial caulking stress can be relieved (reduced) by slightly widening the caulking hole 12 of the strap 1 in the axial direction, the caulking strength is maintained due to the circumferential stress.

Regarding a relationship of the repelling force explained in connection with FIG. 2, it is also true in other embodiments which will be described later. Further, while an example that the stress reducing means are provided on one end 1a of the strap 1 to which the apply side bracket 2 is joined was explained, it should be noted that the stress reducing means shown in FIGS. 2 to 7 can also be provided similarly on the other end 1b of the strap 1 to which the anchor side bracket 3 is joined.

FIG. 3 is a partial front view of the end of the strap 1, showing a second embodiment of stress reducing means. In the second embodiment, similar to the first embodiment, caulking holes 13 provided in the end 1a of the strap 1 are aligned with each other in the axial direction and are disposed substantially equidistantly along the axial direction. Each caulking hole 13 is provided with notches 13a formed in one axial end or both axial ends of the hole and opposed to each other diametrically. Due to the presence of these notches 13a, the axial stress can be reduced during the caulking operation.

While an example that the notches 13a are opposed to each other diametrically in the axial direction was explained, such a notch may be provided in only one end of the hole or such notches may be disposed with different orientations. Even if the notches have different orientations, it is preferable that the notches be disposed near the axial direction.

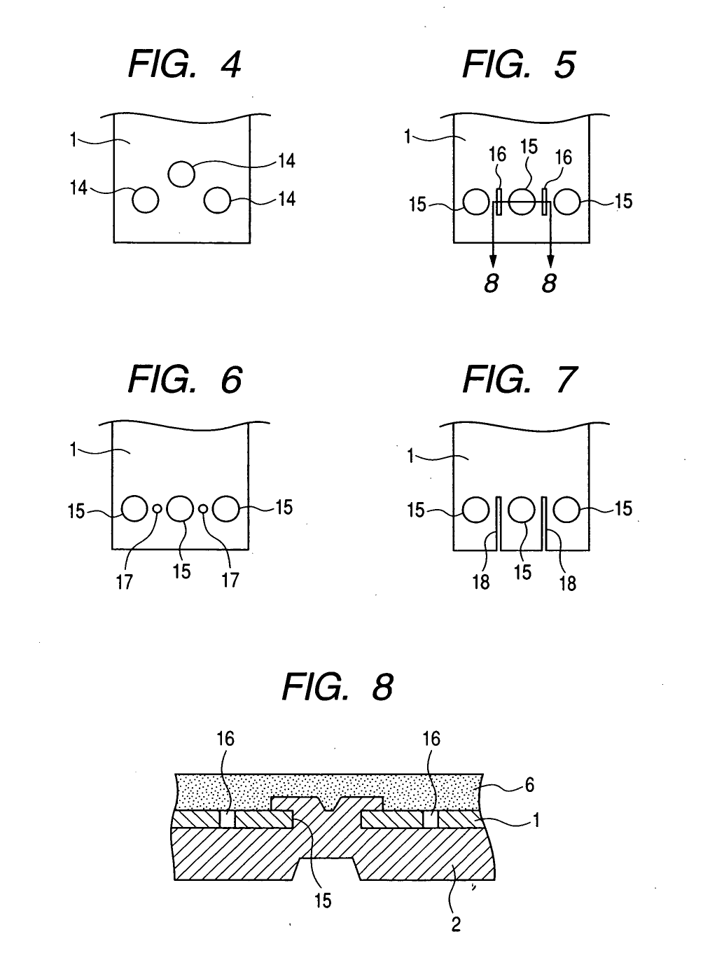

FIG. 4 is a partial front view of the end of the strap 1, showing a third embodiment of stress reducing means. In the third embodiment, caulking holes 14 provided in the end 1a of the strap 1 are not aligned with each other in the axial direction, but, a central caulking hole 14 is offset from the other caulking holes in the circumferential direction. With this arrangement, the axial stress which is pat to be concentrated in the caulking holes 14 can be dispersed, with the result that the axial stress generated by the caulking can be reduced.

FIG. 5 is a partial front view of the end of the strap 1, showing a fourth embodiment of stress reducing means. In the fourth embodiment, caulking holes 15 provided in the end 1a of the strap 1 are aligned with each other in the axial direction and are disposed substantially equidistantly along the axial direction. However, a rectangular hole 16 having a longitudinal length substantially equal to a diameter of the circular caulking hole 15 is provided between the adjacent caulking holes 15.

Each rectangular hole 16 has an axial width smaller than the diameter of the caulking hole 15. In the illustrated embodiment, the axial stress which is apt to be concentrated in the caulking holes 15 can be dispersed by the presence of the holes 16, with the result that the axial stress generated by the caulking can be reduced.

FIG. 8 is a partial sectional view taken along the line 8-8 in FIG. 5 and shows a relationship between the rectangular holes 16 and the caulking 16 and a condition that the apply side bracket 2, strap 1 and friction material 6 are joined to each other without generating undulation. Incidentally, this relationship is generally similar to in other embodiments.

FIG. 6 is a partial front view of the end of the strap 1, showing a fifth embodiment of stress reducing means. In the fifth embodiment, similar to the fourth embodiment, caulking holes 15 provided in the end 1a of the strap 1 are aligned with each other in the axial direction and are disposed substantially equidistantly along the axial direction. However, a small hole 17 which is relatively smaller than the diameter of the circular caulking hole 15 is provided between the adjacent caulking holes 15.

In the illustrated embodiment, the axial stress which is apt to be concentrated in the caulking holes 15 can be dispersed by the presence of the small holes 17, with the result that the axial stress generated by the caulking can be reduced. Further, while an example that only one small hole 17 is provided between the adjacent caulking holes 15 was explained, a plurality of such small holes may be disposed between the adjacent caulking holes in the circumferential direction or the axial direction, preferably in the circumferential direction.

FIG. 7 is a partial front view of the end of the strap 1, showing a sixth embodiment of stress reducing means. In the sixth embodiment, similar to the fourth embodiment, caulking holes 15 provided in the end 1a of the strap 1 are aligned with each other in the axial direction and are disposed substantially equidistantly along the axial direction. A slit 18 extending up to a free end of the end 1a of the strap 1 in the circumferential direction is provided between the adjacent caulking holes 15.

Each slit 18 extends from a position corresponding to an end opposite to a free end of the caulking hole 15 up to the free end of the strap. However, the circumferential length of the slit 18 is not necessarily be limited to this, but the slit may extend beyond the opposite end of the caulking hole. Further, while an example that the single slit 18 is provided between the adjacent caulking holes 15 was explained, two or more slits may be provided between the adjacent caulking holes. In the illustrated embodiment, the axial stress which is apt to be concentrated in the caulking holes 15 can be dispersed by the presence of the small holes 17, with the result that the axial stress generated by the caulking can be reduced.

In the above-mentioned embodiments, while an example that the circular or elliptical caulking holes are used was explained, the present invention is not limited to this example. For example, the caulking hole may be square, polygonal or the like. Further, the number of holes provided in the strap along the axial direction is not limited to three, but one or two or four or more holes may be provided.

Further, although any configuration of the caulking hole may be selected, the caulking hole is preferably configured so that the axial caulking stress is relieved and the caulking strength is maintained by the circumferential stress. That is to say, it is preferable that the configuration of the caulking hole be selected not to influence upon the required caulking strength.

In the above-mentioned embodiments, while an example that holes or slits provided between the caulking holes are shown as the stress reducing means for reducing the axial stress was explained, for example, in place of the holes, the stress reducing means may be constituted by recesses formed on the surface of the strap 1. Further, while the apply side bracket 2 and the anchor side bracket 3 were shown to have different shapes, these brackets may have the same shape.

This application claims priority from Japanese Patent Application No. 2004-295794 filed on Oct. 8, 2004, which is hereby incorporated by reference herein.

What is claimed is:

1. A brake band in which a bracket is joined to an end of a curved strap and a friction material is provided on an inner surface of said strap, wherein:
stress reducing means for reducing axial stress are provided on said strap.

2. A brake band according to claim 1, wherein said bracket has a projection and is joined to said strap by caulking said projection in a caulking hole formed in the end of said strap, and said stress reducing means include said caulking hole provided an elongated hole having a larger axial diameter.

3. A brake band according to claim 1, wherein said bracket has a projection and is joined to said strap by caulking said projection in a caulking hole formed in the end of said strap, and said stress reducing means include notches formed in one axial end or both axial ends of said caulking hole.

4. A brake band according to claim 1, wherein said bracket has projections and is joined to said strap by caulking said projections in a plurality of caulking holes formed in the end of said strap, and said stress reducing means include said caulking holes arranged in an offset manner along a circumferential direction of said strap.

5. A brake band according to claim 1, wherein said bracket has projections and is joined to said strap by caulking said projections in a plurality of caulking holes formed in the end of said strap, and said stress reducing means include a small hole smaller than said caulking hole and provided between said caulking holes.

6. A brake band according to claim 5, wherein said small hole has a substantially rectangular shape having an axial width smaller than a diameter of said caulking hole.

7. A brake band according to claim 5, wherein said small hole has a substantially circular shape having a diameter smaller than a diameter of said caulking hole.

8. A brake band according to claim 1, wherein said bracket has projections and is joined to said strap by caulking said projections in a plurality of caulking holes formed in the end of said strap, and said stress reducing means include a slit provided between said caulking holes and extending up to the end of said strap.

9. A brake band according to claim 8, wherein said slit has an axial width smaller than a diameter of said caulking hole.
